(19) United States
(12) Patent Application Publication
(10) Pub. No.: US 2005/0077983 A1
(43) Pub. Date: Apr. 14, 2005

(54) Device for filtering signals in the K band including a dielectric resonator made from a material that is not temperature-compensated

(75) Inventor: Yannick Latouche, Leguevin (FR)

Correspondence Address: SUGHRUE MION,PLLC, Suite 800, 2100 Pennsylvania Avenue, N.W., Washington, DC, 20037-3213, US

(73) Assignee: ALCATEL

(21) Appl. No.: 10/949,189

(22) Filed: Sep. 27, 2004

(30) Foreign Application Priority Data
Oct. 14, 2003 (FR) 03 11 971

(51) Int. Cl. H01P 1/20; H01P 7/10

(52) U.S. Cl. 333/202; 333/219.1

(57) ABSTRACT

A device for filtering signals in the K band comprises a resonant cavity provided with a dielectric resonator made from a dielectric material that is not temperature compensated.

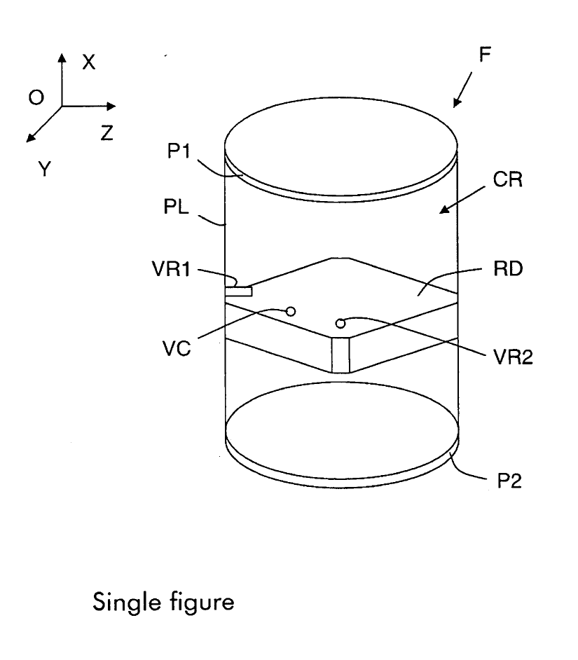

### CROSS-REFERENCE TO RELATED APPLICATIONS

This application is based on French Patent Application No. 03 11 971 filed Oct. 14, 2003, the disclosure of which is hereby incorporated by reference thereto in its entirety, and the priority of which is hereby claimed under 35 U.S.C. §119.

### BACKGROUND OF THE INVENTION

1. Field of the Invention

The field of the invention is that of microwave filters, more particularly that of devices for filtering signals in the K band.

2. Description of the Prior Art

In the present context, the expression “K band” refers to the Ku band of receive frequencies from 13.7 GHz to 15.6 GHz and transmit frequencies from 10.7 GHz to 12.8 GHz and the Ka band of receive frequencies from 27.5 GHz to 30 GHz and transmit frequencies from 18.2 GHz to 20.2 GHz.

There are two main types of device for filtering microwave signals. Devices of the first type define an “empty” resonant cavity, i.e. a cavity containing no dielectric resonator, and devices of the second type define a resonant cavity containing a dielectric resonator.

The person skilled in the art knows that the higher the frequency of the signals to be filtered, the smaller must be the dimensions of the resonant cavity. The smaller these dimensions, the greater the risk of the resonant cavity suffering high “insertion” losses and therefore the greater risk that its quality factor Q may be low. In other words, the greater the insertion losses, the less power the filter device is able to withstand.

Filter devices of the first type have relatively low insertion losses and may therefore be used to filter signals in the K band. However, because they comprise no dielectric material, their dimensions are relatively large, and they are therefore reserved for high-power applications, for example in output multiplexers (Omux).

In filter devices of the second type, the insertion losses may be of metallic and/or dielectric origin, depending on the cavity mode.

In resonant cavities in which the excited mode is referred to as a “cavity” mode, for example the TE 101 mode (in the case of the “plate” technology), the insertion losses are essentially of metallic origin. This is because the electric field is primarily outside the dielectric resonator, so that the insertion losses are essentially caused by the surface state of the metal parts that constitute the resonant cavities. Insertion losses may therefore be partly limited by taking particular care with the treatment of the metal surfaces of the resonant cavities. The TE 101 mode represents an excellent compromise between dimensions and mass, microwave (RF) performance, and ease of use (in terms of cost), when it is used for filtering in the C band (at frequencies below approximately 6.4 GHz). However, this compromise is no longer achieved if the frequency of the signals to be filtered is greater than the upper frequency of the C band, and in particular if it is in the K. band (for which the TE 221 mode is preferred).

In resonant cavities in which the excited mode is referred to as a “resonator” mode, for example the TE 221 mode (again in the case of the “plate” technology), insertion losses are primarily of dielectric origin and to a lesser degree of metallic origin. This is because the electric field is primarily confined within the dielectric resonator, so that insertion losses are caused mainly by the loss tangent of the dielectric material that constitutes the resonator, and to a lesser degree by the surface state of the metal parts that constitute the resonant cavities. These devices therefore necessitate not only resonant cavities having a particularly carefully finished surface state, but also dielectric materials having a very low loss tangent.

Because of the constraints referred to above, devices of the second type, in which the resonance mode is the TE 101 mode, are preferred only for filtering signals whose frequency does not exceed the upper limit of the C band, in low-power and high-power applications, and devices of the second type, in which the resonance mode is the TE 221 mode, are preferred only for filtering signals at frequencies above 6.4 GHz, only in low-power applications.

However, the resonant cavities are subject to temperature variations related to the thermal environment and to the RF power, which induce dimensional variations that in turn induce a shift in the resonant frequency. To overcome this major drawback, ceramic type dielectric materials are used that consist of a mixture of a base material and one or more thermal (or frequency) compensation materials. Now, these additional materials introduce high insertion losses, which make them unusable for filtering signals in the K band in high-power applications, for example in output multiplexers (Omux).

Consequently, at present only devices of the first type, which are limited by dimensional constraints, are used to filter signals in the K band.

Thus an object of the invention is to improve upon this situation.

### SUMMARY OF THE INVENTION

To this end the invention proposes a device for filtering signals in the K band comprising a resonant cavity provided with a dielectric resonator made from a dielectric material that is not temperature compensated.

In the present context the expression “dielectric material that is not temperature compensated” means a dielectric material consisting of a base material with no additional material to provide temperature compensation.

In one particularly advantageous embodiment, the resonant cavity has a substantially circular cylindrical shape with an inside diameter from, 20 mm to 30 mm and a height from 10 mm to 25 mm.

The invention also proposes a K band signal multiplexer equipped with at least one filter device of the type described hereinabove. For example, the multiplexer is a blocking multiplexer with four-pole filter devices.

The invention is particularly suitable for filtering signals in the Ku band, although this is not limiting on the invention.

### BRIEF DESCRIPTION OF THE DRAWING

Other features and advantages of the invention will become apparent on reading the following detailed description and examining the appended drawing, the single FIGURE of which represents diagrammatically one embodiment of a filter device of the invention.

The appended drawing constitutes part of the description of the invention and may, if necessary, contribute to the definition of the invention.

### DETAILED DESCRIPTION OF THE PREFERRED EMBODIMENT

An object of the invention is to filter signals in the K band, in particular in high-power applications.

The appended FIGURE shows one embodiment of a filter device F of the invention. A filter device F of this kind may be integrated into a filter, for example, in turn integrated into a blocking multiplexer with four-pole filters, for example. A filter is generally made up of a plurality of filter devices F separated from each other by an iris (or the like). The blocking multiplexer is an output multiplexer (Omux), for example, and its filters are dedicated to filtering signals in the Ku band, for example.

Of course, the filter device F of the invention may be integrated into equipment types other than those cited above.

A filter device F according to the invention comprises a resonant cavity CR, for example of tubular (circular cylindrical) shape, housing a dielectric resonator RD made from a dielectric material that is not temperature-compensated.

In the present context the expression “material that is not temperature-compensated” means a material with no additional material intended to compensate variations in the resonant frequency as a function of temperature.

It is important to note that the invention is not limited to this type of resonant cavity CR alone. It also relates to resonant cavities of rectangular or elliptical cross section.

The filter device F comprises a waveguide body comprising a lateral wall PL that extends in a longitudinal direction OX and delimits the resonant cavity CR in conjunction with opposite first and second end walls P1, P2 lying substantially in transverse planes YZ (perpendicular to the direction OX).

The resonant cavity CR being of circular cylindrical shape here, the lateral wall PL therefore defines a circular cylinder and the first and second end walls P1, P2 are disks. The lateral wall PL and the end walls P1 and P2 are preferably made of aluminum.

The dielectric resonator RD is made of alumina (Al₂O₃), for example, and has no additional temperature-compensation material, having a floating quality factor Q of the order of 18 500 when it is integrated into the resonant cavity CR.

Of course, the invention is not limited only to this dielectric material that is not temperature compensated. It relates to any type of dielectric material that is not temperature compensated, and in particular, although they are of less benefit than alumina, to dielectric materials based on barium or zirconium titanate.

The dielectric resonator RD shown uses the “plate” technology. It is fastened to the lateral wall PL, for example by a differential expansion on heating technique. In this example, the resonant cavity CR is of the bimode type (i.e. it has a resonant mode with two polarizations). It therefore has two adjustment screws VR1 and VR2 for fine adjustment of each polarization mode and a coupling screw VC to provide the coupling between the two polarization modes. Of course, other embodiments may be envisaged, in particular embodiments of the monomode type.

In one particularly advantageous embodiment, the resonant cavity CR has an inside diameter from 20 mm to 30 mm and a height from 10 mm to 25 mm.

In this case, the dielectric resonator RD has a diameter from 20 mm to 30 mm and a thickness (height) from 1 mm to 3 mm, for example. The dimensions of the dielectric resonator RD and those of the resonant cavity CR define the resonant frequency and the excited mode.

For example, if the resonant cavity CR has an inside diameter of approximately 25 mm and a height of approximately 16 mm and if the dielectric resonator RD has a diameter of approximately 25 mm and a thickness (height) of approximately 2 mm, a resonant frequency of approximately 12 GHz is obtained for a TE 221 excited mode (resonator mode).

An embodiment of this kind may replace a filter device of the first (empty cavity) type having an inside diameter of approximately 25 mm and a height of approximately 46 mm. Accordingly, when such filter devices are installed in a blocking output multiplexer (Omux) with four-pole filters, they provide a saving of approximately 120 mm along the longitudinal axis.

To enable each filter device F to withstand temperature variations that are associated with the thermal environment or induced by high-power signals, at least one of the end walls P1, P2 delimiting its resonant cavity CR may be equipped with an appropriate device for compensating dimensional variations. Many devices of this type are known to the person skilled in the art, in particular in filter devices of the first (empty resonant cavity) type. Devices relying on deformation of caps (or end walls) may be cited by way of example.

Of course, a filter equipped with one or more devices of the invention may be used with no additional compensation device if a substantially constant temperature may be guaranteed, for example if it is cooled.

The invention is not limited to the filter device and multiplexer embodiment described hereinabove by way of example only, but encompasses all variants that the person skilled in the art might envisage that fall within the scope of the following claims.

Thus filter devices with alumina dielectric resonators have been described. However, the invention is not limited to this dielectric material that is not temperature compensated.

1. A device for filtering signals in the K band comprising a resonant cavity provided with a dielectric resonator made from a dielectric material that is not temperature compensated.

2. The filter device claimed in claim 1 wherein said dielectric material is alumina.

3. The filter device claimed in claim 1 wherein said dielectric resonator is implemented in the “plate” technology.

4. The filter device claimed in claim 2 wherein said dielectric resonator is implemented in the “plate” technology.

5. The filter device claimed in claim 1 wherein said resonant cavity has a substantially circular cylindrical shape with an inside diameter from 20 mm to 30 mm and a height from 10 mm to 25 mm.

6. The filter device claimed in claim 2 wherein said resonant cavity has a substantially circular cylindrical shape with an inside diameter from 20 mm to 30 mm and a height from 10 mm to 25 mm.

7. The filter device claimed in claim 3 wherein said resonant cavity has a substantially circular cylindrical shape with an inside diameter from 20 mm to 30 mm and a height from 10 mm to 25 mm.

8. The filter device claimed in claim 4 wherein said resonant cavity has a substantially circular cylindrical shape with an inside diameter from 20 mm to 30 mm and a height from 10 mm to 25 mm.
